(19) United States
(12) Patent Application Publication
(10) Pub. No.: US 2019/0380332 A1
(43) Pub. Date: Dec. 19, 2019

(54) ENHANCEMENT OF SOIL HERBICIDE ACTIVITY WITH ANIONIC ALKOXYLATED PHENOLS

(71) Applicant: BASF SE, Ludwigshafen am Rhein (DE)

(72) Inventors: Ulrich Steinbrenner, Limburgerhof (DE); Liliana Parra Rapado, Limburgerhof (DE); Marc Nolte, Limburgerhof (DE); Yvonne Dieckmann, Ludwigshafen (DE); Kristin Hanzlik, Limburgerhof (DE)

(21) Appl. No.: 16/481,696

(22) PCT Filed: Jan. 24, 2018
(86) PCT No.: PCT/EP2018/051631

§ 371 Date: Jul. 29, 2019

(30) Foreign Application Priority Data
Feb. 2, 2017 (EP) 17154415.8

(51) Int. Cl. A01N 25/24; A01N 33/18; A01N 25/28; A01N 25/08

(52) U.S. Cl. CPC A01N 25/24; A01N 25/08; A01N 25/28; A01N 33/18

(57) ABSTRACT

A method for controlling unwanted vegetation including the application of a water-insoluble herbicide and a soil mobilizer to a soil. The weight ratio of the herbicide to the soil mobilizer is from 1:0.8 to 1:50, and the soil mobilizer is of the formula I as defined in the disclosure. Also disclosed is a composition including a water-insoluble herbicide and the soil mobilizer. The weight ratio of the herbicide to the soil mobilizer is from 1:0.8 to 1:50. A use of the soil mobilizer for enhancement of the herbicidal activity of a herbicide applied to soil is disclosed.

The present invention refers to a method for controlling unwanted vegetation comprising the application of a water-insoluble herbicide and a soil mobilizer to a soil, where the weight ratio of the herbicide to the soil mobilizer is from 1:0.8 to 1:50, and where the soil mobilizer is of the formula I as defined herein. The invention further relates to a composition comprising a water-insoluble herbicide and the soil mobilizer, where the weight ratio of the herbicide to the soil mobilizer is from 1:0.8 to 1:50; and to a use of the soil mobilizer for enhancement of the herbicidal activity of a herbicide applied to soil. Combinations of preferred features with other preferred features are comprised by the present invention.

Many water-insoluble herbicides have barely any soil mobility after application to soil. In particular cases, however, increased and controlled soil mobility is advantageous. Especially in pre-emergence applications of herbicides directly to soil such features are important, for example to improve the control of deeply seeded weed seeds.

Object was to find possibilities to increase the activity of herbicides applied to soil, and to increase their solubility, mobility and bioavailability.

The object was solved by a method for controlling unwanted vegetation comprising the application of a water-insoluble herbicide and a soil mobilizer to a soil, where the weight ratio of the herbicide to the soil mobilizer is from 1:0.8 to 1:50, and where the soil mobilizer is of the formula I

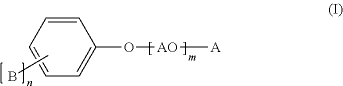

where

B is alkyl, aryl or arylalkyl,

AO is C₂-C₆ alkyleneoxy,

A is a sulfate or phosphate group,

n is from 1 to 3, and

m is from 1 to 100.

In another form the object was solved by a composition comprising a water-insoluble herbicide and a soil mobilizer, where the weight ratio of the herbicide to the soil mobilizer is from 1:0.8 to 1:50, and where the soil mobilizer is of the formula I.

In another form the object was solved by a use of the soil mobilizer of the formula I for enhancement of the herbicidal activity of a herbicide applied to soil.

The application of the herbicide and a soil mobilizer according the method, or the application of the composition according to the invention is usually done from a predosage device, a knapsack sprayer, a spray tank, a spray plane, or an irrigation system.

Usually, an agrochemical concentrate is made up with water, buffer, and/or further auxiliaries to the desired application concentration and the ready-to-use spray liquor (also called a tank mix) is thus obtained. 20 to 2000 liters, preferably 50 to 400 liters, of the ready-to-use spray liquor may be applied per hectare of agricultural useful area.

The application rate of the herbicide may depend on the kind of effect desired from 0.001 to 40 kg per hectare (ha), preferably 0.01 to 20 kg/ha, more preferably from 0.1 to 10 kg/ha.

The soil mobilizer is preferably applied with an application rate of 0.5 to 50 kg/ha, more preferably 2 to 40 kg/ha, and in particular with 5 to 20 kg/ha.

The weight ratio of the herbicide to the soil mobilizer is preferably from 1:1 to 1:20, more preferably from 1:2 to 1:10, and in particular from 1:3 to 1:8.

The application of the herbicide and the soil mobilizer to the soil can be done simultaneously or in succession, preferably simultaneously.

The application can be done before, during and/or after, preferably before, the emergence of the unwanted vegetation.

When the application of the herbicide and the soil mobilizer to the soil are done simultaneously, they may be applied jointly, e.g. as tank mix, or separately, e.g. from two separate spray tanks which are applied simultaneously to the soil.

When the application of the herbicide and the soil mobilizer to the soil are done in succession, the time interval between the individual applications should be selected to ensure that the compound applied first still occurs at the site of application in a sufficient amount at the time of application of the other compound. The order of application is not essential for working of the present invention. When applying the herbicide and the soil mobilizer in succession the time between both applications may vary, such as ranging from 0.25 hour to 30 days, preferably from 0.5 hour to 14 days, particularly from 1 hour to 7 days or from 1.5 hours to 5 days, even more preferred from 2 hours to 1 day.

The soil may be clay, sandy clay, sand, loamy sand, sandy loam clay, sandy loam silt, sandy loam, or loam. Preferred soil is clay, sandy clay, sandy loam clay, sandy loam silt, sandy loam, or loam. More preferred soil is clay or loam.

The undesired vegetation is also often known as weeds. The undesired vegetation may be understood to include any vegetation growing in non-crop-areas or at a crop plant site or locus of seeded and otherwise desired crop, where the vegetation is any plant species, including their germinant seeds, emerging seedlings and established vegetation, other than the seeded or desired crop (if any). Weeds, in the broadest sense, are plants considered undesirable in a particular location. The term “unwanted vegetation” typically refers to living plants and seeds of the unwanted vegetation, wherein seeds of the unwanted vegetation are preferred.

The method, composition, or use according to the invention can be employed in various crop plants for controlling unwanted vegetation. Usually, the herbicide does not result in a substantial damage to the crops plants.

Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays. Preferred crops are crops of cereals, corn, soybeans, rice, oilseed rape, cotton, potatoes, peanuts or permanent crops. Preferred crops are Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N.rustica), Olea europaea, Oryza sativa , Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays. Especially preferred crops are crops of cereals, corn, soybeans, rice, oilseed rape, cotton, potatoes, peanuts or permanent crops.

Further examples of suitable crops are genetically modified plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant in order to improve certain properties of the plant. Such genetic modifications also include but are not limited to targeted post-translational modification of protein(s), oligo- or polypeptides. e.g., by inclusion therein of amino acid mutation(s) that permit, decrease, or promote glycosylation or polymer additions such as prenylation, acetylation farnesylation, or PEG moiety attachment.

Plants that have been modified by breeding, mutagenesis or genetic engineering, e.g. have been rendered tolerant to applications of specific classes of herbicides, such as auxinic herbicides such as dicamba or 2,4-D; bleacher herbicides such as 4-hydroxyphenylpyruvate dioxygenase (HPPD) inhibitors or phytoene desaturase (PDS) inhibitors; acetolactate synthase (ALS) inhibitors such as sulfonylureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase inhibitors; lipid biosynthesis inhibitors such as acetylCoA carboxylase (ACCase) inhibitors; or oxynil (i.e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxinic herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Several cultivated plants have been rendered tolerant to herbicides by mutagenesis and conventional methods of breeding, e.g., Clearfield® summer rape (Canola, BASF SE, Germany) being tolerant to imidazolinones, e.g., imazamox, or ExpressSun® sunflowers (DuPont, USA) being tolerant to sulfonyl ureas, e.g., tribenuron. Genetic engineering methods have been used to render cultivated plants such as soybean, cotton, corn, beets and rape, tolerant to herbicides such as glyphosate, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, CryIIIB(b1) or Cry9c; vegetative insecticidal proteins (VIP), e.g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coleoptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes (e.g., potato cultivars, which express resistance genes acting against Phytophthora infestans derived from the Mexican wild potato, Solanum bulbocastanum) or T4-lyso-zym (e.g., potato cultivars capable of synthesizing these proteins with increased resistance against bacteria such as Erwinia amylovora). The methods for producing such genetically modified plants are generally known to the person skilled in the art and are described, e.g., in the publications mentioned above. Furthermore, plants are also covered that are by the use of recombinant DNA techniques capable to synthesize one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants. Furthermore, plants are also covered that contain by the use of recombinant DNA techniques a modified amount of ingredients or new ingredients, specifically to improve human or animal nutrition, e.g., oil crops that produce health-promoting long-chain omega-3 fatty acids or unsaturated omega-9 fatty acids (e.g., Nexera® rape, Dow AgroSciences, Canada). Furthermore, plants are also covered that contain by the use of recombinant DNA techniques a modified amount of ingredients or new ingredients, specifically to improve raw material production, e.g., potatoes that produce increased amounts of amylopectin (e.g. Amflora® potato, BASF SE, Germany).

Herbicides are a well known compounds which can be found for example in the Pesticide Manual, 17th Ed. (2015), The British Crop Protection Council, London. Suitable herbicides are for example from the class b1) to b15):
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitosis inhibitors;
b10) inhibitors of the synthesis of very long chain fatty acids (VLCFA inhibitors);
b11) cellulose biosynthesis inhibitors;
b12) decoupler herbicides;
b13) auxinic herbicides;
b14) auxin transport inhibitors; and
b15) other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin (CAS 403640-27-7), methyl azide, methyl bromide, methyl-dymron, methyl iodide, MSMA, oleic acid, oxaziclomefone, pelargonic acid, pyributicarb, quinoclamine, triaziflam, tridiphane and 6 chloro-3-(2-cyclopropyl-6-methylphenoxy)-4-pyridazinol (CAS 499223-49-3) and its salts and esters;
   including their agriculturally acceptable salts or derivatives.

If the pesticides as described herein are capable of forming geometrical isomers, for example E/Z isomers, it is possible to use both, the pure isomers and mixtures thereof. If the pesticides as described herein have one or more centers of chirality and, as a consequence, are present as enantiomers or diastereomers, it is possible to use both, the pure enantiomers and diastereomers and their mixtures. If the pesticides as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, heptylammonium, dodecylammonium, tetradecylammonium, tetramethylammonium, tetraethylammonium, tetrabutylammonium, 2-hydroxyethylammonium (olamine salt), 2-(2-hydroxyeth-1-oxy)eth-1-ylammonium (diglycolamine salt), di(2-hydroxyeth-1-yl)ammonium (diolamine salt), tris(2-hydroxyethyl)ammonium (trolamine salt), tris(2-hydroxypropyl)ammonium, benzyltrimethylammonium, benzyltriethylammonium, N,N,N-trimethylethanolammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis-(3-aminopropyl)methylamine and diethylenetriamine.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

Pesticides as described herein having a carboxyl group can be employed in the form of the acid, in the form of an agriculturally suitable salt as mentioned above or else in the form of an agriculturally acceptable derivative, for example as amides, such as mono- and di-C₁-C₆-alkylamides or arylamides, as esters, for example as allyl esters, propargyl esters, C₁-C₁₀-alkyl esters, alkoxyalkyl esters, tefuryl ((tetrahydrofuran-2-yl)methyl) esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C₁-C₁₀-alkylthio ester is the ethylthio ester.

According to a first embodiment the herbicide comprises at least one inhibitor of the lipid biosynthesis (herbicide b1). These are compounds that inhibit lipid biosynthesis. Inhibition of the lipid biosynthesis can be affected either through inhibition of acetylCoA carboxylase (hereinafter termed ACC herbicides) or through a different mode of action (hereinafter termed non-ACC herbicides). The ACC herbicides belong to the group A of the HRAC classification system whereas the non-ACC herbicides belong to the group N of the HRAC classification.

According to a second embodiment the herbicide comprises at least one ALS inhibitor (herbicide b2). The herbicidal activity of these compounds is based on the inhibition of acetolactate synthase and thus on the inhibition of the branched chain amino acid biosynthesis. These inhibitors belong to the group B of the HRAC classification system. According to a third embodiment the herbicide comprises at least one inhibitor of photosynthesis (herbicide b3). The herbicidal activity of these compounds is based either on the inhibition of the photosystem II in plants (so-called P511 inhibitors, groups C1, C2 and C3 of HRAC classification) or on diverting the electron transfer in photosystem I in plants (so-called PSI inhibitors, group D of HRAC classification) and thus on an inhibition of photosynthesis. Amongst these, PSII inhibitors are preferred. According to a fourth embodiment the herbicide comprises at least one inhibitor of protoporphyrinogen-IX-oxidase (herbicide b4). The herbicidal activity of these compounds is based on the inhibition of the protoporphyrinogen-IX-oxidase. These inhibitors belong to the group E of the HRAC classification system. According to a fifth embodiment the herbicide comprises at least one bleacher-herbicide (herbicide b5). The herbicidal activity of these compounds is based on the inhibition of the carotenoid biosynthesis. These include compounds which inhibit carotenoid biosynthesis by inhibition of phytoene desaturase (so-called PDS inhibitors, group F1 of HRAC classification), compounds that inhibit the 4-hydroxyphenyl-pyruvate-dioxygenase (HPPD inhibitors, group F2 of HRAC classification), compounds that inhibit DOXsynthase (group F4 of HRAC class) and compounds which inhibit carotenoid biosynthesis by an unknown mode of action (bleacher—unknown target, group F3 of HRAC classification). According to a sixth embodiment the herbicide comprises at least one EPSP synthase inhibitor (herbicide b6). The herbicidal activity of these compounds is based on the inhibition of enolpyruvyl shikimate 3-phosphate synthase, and thus on the inhibition of the amino acid biosynthesis in plants. These inhibitors belong to the group G of the HRAC classification system. According to a seventh embodiment the herbicide comprises at least one glutamine synthetase inhibitor (herbicide b7). The herbicidal activity of these compounds is based on the inhibition of glutamine synthetase, and thus on the inhibition of the aminoacid biosynthesis in plants. These inhibitors belong to the group H of the HRAC classification system. According to an eighth embodiment the herbicide comprises at least one DHP synthase inhibitor (herbicide b8). The herbicidal activity of these compounds is based on the inhibition of 7,8-dihydropteroate synthase. These inhibitors belong to the group I of the HRAC classification system. According to a ninth embodiment the herbicide comprises at least one mitosis inhibitor (herbicide b9). The herbicidal activity of these compounds is based on the disturbance or inhibition of microtubule formation or organization, and thus on the inhibition of mitosis. These inhibitors belong to the groups K1 and K2 of the HRAC classification system. Among these, compounds of the group K1, in particular dinitroanilines, are preferred. According to a tenth embodiment the herbicide comprises least one VLCFA inhibitor (herbicide b10). The herbicidal activity of these compounds is based on the inhibition of the synthesis of very long chain fatty acids and thus on the disturbance or inhibition of cell division in plants. These inhibitors belong to the group K3 of the HRAC classification system. According to an eleventh embodiment the herbicide comprises at least one cellulose biosynthesis inhibitor (herbicide b11). The herbicidal activity of these compounds is based on the inhibition of the biosynthesis of cellulose and thus on the inhibition of the synthesis of cell walls in plants. These inhibitors belong to the group L of the HRAC classification system. According to a twelfth embodiment the herbicide comprises at least one decoupler herbicide (herbicide b12). The herbicidal activity of these compounds is based on the disruption of the cell membrane. These inhibitors belong to the group M of the HRAC classification system. According to a thirtheenth embodiment the herbicide comprises at least one auxinic herbicide (herbicide b13). These include compounds that mimic auxins, i.e. plant hormones, and affect the growth of the plants. These compounds belong to the group O of the HRAC classification system. According to a fourteenth embodiment the herbicide comprises at least one auxin transport inhibitor (herbicide b14). The herbicidal activity of these compounds is based on the inhibition of the auxin transport in plants. These compounds belong to the group P of the HRAC classification system. As to the given mechanisms of action and classification of the active substances, see e.g. “HRAC, Classification of Herbicides According to Mode of Action” (http://www.plantprotection.org/hrac/MOA.html).

In one form preference is given to those herbicides comprising at least one herbicide B selected from herbicides of class b4, b5, b9, b10, b11 and b15.

Preferred herbicides are the herbicides

b4) from the group of the protoporphyrinogen-IX oxidase inhibitors:

acifluorfen, acifluorfen-sodium, azafenidin, bencarbazone, benzfendizone, bifenox, butafenacil, carfentrazone, carfentrazone-ethyl, chlomethoxyfen, chlorphthalim, cinidon-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, tiafenacil, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoro-methylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoro-methylphenoxy)-5-methyl-1H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate (CAS 948893-00-3), and 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4);

b5) from the group of the bleacher herbicides:

PDS inhibitors: beflubutamid, diflufenican, fluridone, flurochloridone, flurtamone, norflurazon, picolinafen, and 4-(3-trifluoromethylphenoxy)-2-(4-trifluoromethylphenyl)pyrimidine (CAS 180608-33-7), HPPD inhibitors: benzobicyclon, benzofenap, bicyclopyrone, clomazone, fenquinotrione, isoxaflutole, mesotrione, oxotrione (CAS 1486617-21-3), pyrasulfotole, pyrazolynate, pyrazoxyfen, sulcotrione, tefuryltrione, tembotrione, tolpyralate, topramezone, bleacher, unknown target: aclonifen, amitrole flumeturon and 2-chloro-3-methylsulfanyl-N-(1-methyltetrazol-5-yl)-4-(trifluoromethyl)benzamide (CAS 1361139-71-0);

b9) from the group of the mitosis inhibitors:

compounds of group K1: dinitroanilines such as benfluralin, butralin, dinitramine, ethalfluralin, fluchloralin, oryzalin, pendimethalin, prodiamine and trifluralin, phosphoramidates such as amiprophos, amiprophos-methyl, and butamiphos, benzoic acid herbicides such as chlorthal, chlorthal-dimethyl, pyridines such as dithiopyr and thiazopyr, benzamides such as propyzamide and tebutam; compounds of group K2: carbetamide, chlorpropham, flamprop, flamprop-isopropyl, flamprop-methyl, flamprop-M-isopropyl, flamprop-M-methyl and propham; among these, compounds of group K1, in particular dinitroanilines are preferred;

b10) from the group of the VLCFA inhibitors:

chloroacetamides such as acetochlor, alachlor, amidochlor, butachlor, dimethachlor, dimethenamid, dimethenamid-P, metazachlor, metolachlor, metolachlor-S, pethoxamid, pretilachlor, propachlor, propisochlor and thenylchlor, oxyacetanilides such as flufenacet and mefenacet, acetanilides such as diphenamid, naproanilide, napropamide and napropamide-M, tetrazolinones such fentrazamide, and other herbicides such as anilofos, cafenstrole, fenoxasulfone, ipfencarbazone, piperophos, pyroxasulfone and isoxazoline compounds of the formulae II.1, II. 2, II.3, II.4, II. 5, II.6, II.7, II.8 and II.9

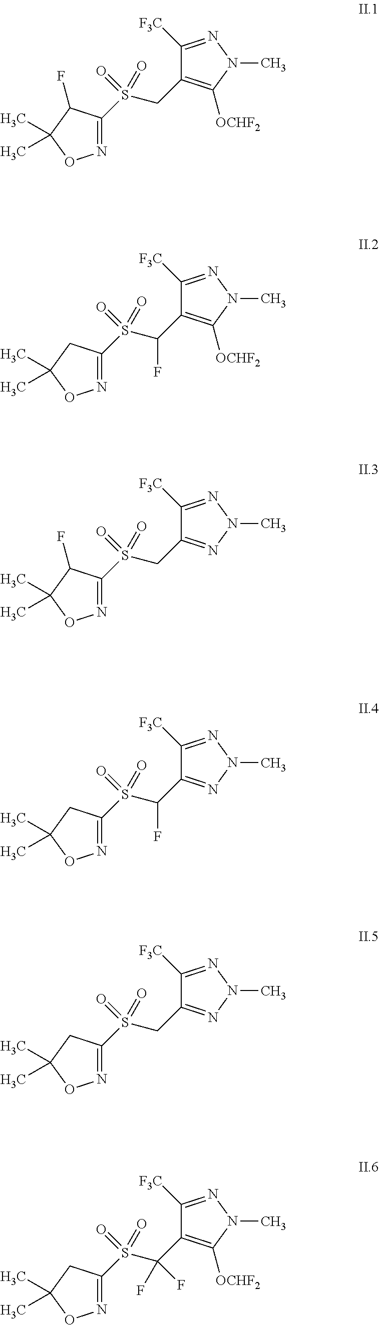

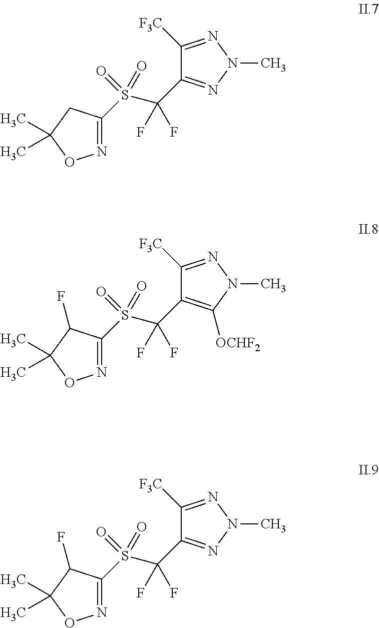

the isoxazoline compounds of the formula (II) are known in the art, e.g. from WO 2006/024820, WO 2006/037945, WO 2007/071900 and WO 2007/096576;

b11) from the group of the cellulose biosynthesis inhibitors:

chlorthiamid, dichlobenil, flupoxam, indaziflam, isoxaben, triaziflam and 1-cyclohexyl-5-pentafluorphenyloxy-1⁴-[1,2,4,6]thiatriazin-3-ylamine (CAS 175899-01-1); and

b15) from the group of the other herbicides: bromobutide, chlorflurenol, chlorflurenol-methyl, cinmethylin, cumyluron, cyclopyrimorate (CAS 499223-49-3) and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin (CAS 403640-27-7), methyl azide, methyl bromide, methyl-dymron, methyl iodide, MSMA, oleic acid, oxaziclomefone, pelargonic acid, pyributicarb, quinoclamine and tridiphane.

More preferred herbicides are:

b4) from the group of the protoporphyrinogen-IX oxidase inhibitors: flumioxazin, oxyfluorfen, pyraflufen, pyraflufen-ethyl, saflufenacil, sulfentrazone, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), and 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0);

b5) from the group of the bleacher herbicides: amitrole, bicyclopyrone, clomazone, diflufenican, fenquinotrione, flumeturon, flurochloridone, isoxaflutole, mesotrione, oxotrione (CAS 1486617-21-3), picolinafen, sulcotrione, tefuryltrione, tembotrione, tolpyralate, topramezone and 2-chloro-3-methylsulfanyl-N-(1-methyltetrazol-5-yl)-4-(trifluoromethyl)enzamide (CAS 1361139-71-0);

b9) from the group of the mitosis inhibitors: pendimethalin and trifluralin;

b10) from the group of the VLCFA inhibitors: acetochlor, cafenstrole, dimethenamid-P, fentrazamide, flufenacet, mefenacet, metazachlor, metolachlor, S-metolachlor, fenoxasulfone, ipfencarbazone and pyroxasulfone; likewise, preference is given to isoxazoline compounds of the formulae II.1, II.2, II.3, II.4, II.5, II.6, II.7, II.8 and II.9 as mentioned above;

b11) from the group of the cellulose biosynthesis inhibitors: indaziflam, isoxaben and triaziflam;

b15) from the group of the other herbicides: cinmethylin, dymon (=daimuron), indanofan, oxaziclomefone.

The assignment of the active compounds to the respective mechanisms of action is based on current knowledge. If several mechanisms of action apply to one active compound, this substance was only assigned to one mechanism of action.

Herbicides having a carboxyl group can be employed in the form of the acid, in the form of an agriculturally suitable salt as mentioned above or else in the form of an agriculturally acceptable derivative. A suitable salt of topramezone is for example topramezone-sodium.

In one form the particularly preferred herbicides are the herbicides as defined above; in particular the herbicides acifluorfen, butafenacil, carfentrazone-ethyl, flumioxazin, fomesafen, oxadiargyl, oxyfluorfen, pyraflufen, pyraflufen-ethyl, saflufenacil, sulfentrazone, trifludimoxazin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyl-oxy]acetate (CAS 353292-31-6), benzobicyclon, bicyclopyrone, clomazone, diflufenican, flurochloridone, isoxaflutole, mesotrione, norflurazone, picolinafen, sulcotrione, tefuryltrione, tembotrione, tolpyralate, topramezone, topramezone-sodium, amitrole, fluometuron, fenquinotrione, pendimethalin, trifluralin, acetochlor, butachlor, cafenstrole, dimethenamid-P, fentrazamide, flufenacet, mefenacet, metazachlor, metolachlor, S-metolachlor, pretilachlor, fenoxasulfone, indaziflam, isoxaben, triaziflam, ipfencarbazone, pyroxasulfone, dymron, indanofan, oxaziclomefone, II.1, II.2, II.3, II.4, II.5, II.6, II.7, II.8, II.9, oxotrione (CAS 1486617-21-3), cinmethylin, 2-chloro-3-methylsulfanyl-N-(1-methyltetrazol-5-yl)-4-(trifluoromethyl)enzamide (CAS 1361139-71-0).

In a preferred form the herbicide comprises a herbicide b9) from the group of the mitosis inhibitors, such as pendimethalin.

In another preferred form the herbicide comprises a herbicide b4) from the group of the protoporphyrinogen-IX oxidase inhibitors, such as trifludimoxazin.

The water insoluble herbicide has usually a a solubility in water (usually at 20° C. at pH 7) of up to 10 g/l, preferably of up to 1 g/l, and in particular up to 100 mg/l.

The herbicide is usually solid at room temperature. Typically, the herbicide has a melting point of at least 25° C., preferably at least 35° C., and in particular at least 45° C.

The soil mobilizer is of the formula I

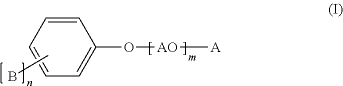

where

B is alkyl, aryl or arylalkyl, preferably aryl or arylalkyl,

AO is C₂-C₆ alkyleneoxy,

A is a sulfate or phosphate group,

n is from 1 to 3, and

m is from 1 to 100.

B is alkyl, aryl or arylalkyl, which means that all B may be the same or may be different in the formula I. For example, in case n is 3 then B may be one phenylethyl and two phenylpropyl. Preferably, all B are the same in the fomula I. B is preferably aryl or arylalkyl. B is in particular arylalkyl, such as phenyl-C₁-C₄-alkyl.

When B is alkyl, it is preferably a C₃-C₂₂ alkyl, more preferably a C₆-C₁₈ alkyl, and in particular a C₉ alkyl, wherein the alkyl may be linear or branched.

The term “aryl”, alone or in combination with other groups, relates to a phenyl or naphthyl group, which can optionally be substituted, such as mono-, di-, or tri-substituted by halogen, alkyl.

Preferred aryl group in B usually is phenyl, naphthyl, or phenyl mono-, di-, or tri-substituted by C₁-C₈ alkyl. More preferred aryl group is phenyl, naphthyl, or phenyl mono-, or di-substituted by C₁-C₄ alkyl. In particular the aryl group in B is phenyl.

The term “arylalkyl” relates to an aryl radical attached to an alkyl group. The term “aryl” has the meaning as defined above.

In a preferred form B is aryl-C₁-C₈-alkyl, more preferably aryl-C₁-C₄-alkyl, and in particular phenylethyl (e.g. Ph-CH(CH₃)—). In another form the arylalkyl group of B may be phenyl-C₁-C₈-alkyl, preferably phenyl-C₁-C₄-alkyl, and in particular Ph-CH(CH₃)—.

The index n is from 1 to 3, preferably from 2 to 3, and in particular from 2,1 to 2,6. The index n may be an integer number or a rational number, which may represent mixtures of molecules with different integer numbers of n.

A is a sulfate or phosphate group, wherein the sulfate is preferred. Any suitable cations may be present, such as alkali, earth alkali or ammonium cations.

AO is C₂-C₆ alkyleneoxy, preferably C₂-C₃ alkyleneoxy, and in particular ethyleneoxy. In another preferred form AO is ethyleneoxy or a mixture of ethyleneoxy group and propyleneoxy.

The index m is from 1 to 100, preferably from 5 to 50, and in particular from 7 to 30.

In a preferred form the soil mobilizer is of the formula I, where

B is aryl-C₁-C₈-alkyl (e.g. phenyl-C₁-C₄-alkyl),

AO is a C₂-C₃ alkyleneoxy group,

A is a sulfate or phosphate group,

n is from 2 to 3, and

m is from 3 to 50.

In another preferred form the soil mobilizer is of the formula I, where

B is phenyl-C₁-C₄-alkyl (e.g. Ph-CH(CH3)-),

AO is ethyleneoxy or a mixture of ethyleneoxy group and propyleneoxy,

A is a sulfate or phosphate,

n is from 2 to 3, and

m is from 3 to 50.

In another preferred form the soil mobilizer is of the formula I, where

B is phenyl-C₁-C₄-alkyl (e.g. Ph-CH(CH3)-),

AO is ethyleneoxy,

A is a sulfate or phosphate,

n is 3, and

m is from 7 to 30.

The composition comprising the water-insoluble herbicide and the soil mobilizer aqueous composition comprising at least 30 wt %, preferably at least 50%, and in particular at least 80% of water.

In one form the composition is an aqueous agrochemical concentrate, such as a suspension concentrate, comprising at least 30 wt %, preferably at least 40 wt %, and in particular at least 50 wt % of water. The aquous agrochemical concentrate is usually diluted with water prior to the application, e.g. to allow spraying.

In another form the composition is an aqueous tank mix comprising at least 60 wt %, preferably at least 75 wt %, and in particular at least 90 wt % of water. Usually, an agrochemical formulation is made up with water and optionally further auxiliaries to the desired application concentration and the tank mix is thus obtained. The tank mix may be prepared
a) by mixing the agrochemical concentrate which contains the soil mobilizer with water, or
b) by mixing the agrochemical formulation (which may be free of the soil mobilizer) with water, the soil mobilizer, and optionally further auxiliaries.

In a preferred form the tank mix is prepared by mixing the agrochemical formulation with water, the soil mobilizer, and optionally further auxiliaries.

The herbicide may be present in dissolved form and/or suspended in particulate form or in microencapsulated form in the composition, preferably in the aqueous composition. Preferably the herbicide is suspended in particulate form or in microencapsulated form in the aquous composition, such as the agrochemical concentrate or the tank mix. In particular, the herbicide is suspended in particulate form in the aquous composition, such as the agrochemical concentrate or the tank mix.

In one form the method may comprise the application of the water-insoluble herbicide (e.g. pendimethalin) and the soil mobilizer, where B is aryl-C₁-C₈-alkyl (e.g. phenyl-C₁-C₄-alkyl), AO is a C₂-C₃ alkyleneoxy group, A is a sulfate or phosphate group, n is from 2 to 3, and m is from 3 to 50, and where the soil mobilizer is applied with an application rate 0.5 to 50 kg/ha, more preferably 2 to 40 kg/ha, and in particular with 5 to 20 kg/ha.

In one form the method may comprise the application of the water-insoluble herbicide (e.g. pendimethalin) and the soil mobilizer, where B is aryl-C₁-C₈-alkyl (e.g. phenyl-C₁-C₄-alkyl), AO is a C₂-C₃ alkyleneoxy group, A is a sulfate or phosphate group, n is from 2 to 3, and m is from 3 to 50, where the application is done before the emergence of the unwanted vegetation, and where the soil mobilizer is applied with an application rate 0.5 to 50 kg/ha, more preferably 2 to 40 kg/ha, and in particular with 5 to 20 kg/ha.

In another form the method may comprise the application of the water-insoluble herbicide (e.g. pendimethalin) and the soil mobilizer, where B is aryl-C₁-C₈-alkyl (e.g. phenyl-C₁-C₄-alkyl), AO is a C₂-C₃ alkyleneoxy group, A is a sulfate or phosphate group, n is from 2 to 3, and m is from 3 to 50, and where the soil mobilizer is applied with an application rate 0.5 to 50 kg/ha, more preferably 2 to 40 kg/ha, and in particular with 5 to 20 kg/ha.

In another form the method may comprise the application of the water-insoluble herbicide (e.g. pendimethalin) and the soil mobilizer, where B is aryl-C₁-C₈-alkyl (e.g. phenyl-C₁-C₄-alkyl), AO is a C₂-C₃ alkyleneoxy group, A is a sulfate or phosphate group, n is from 2 to 3, and m is from 3 to 50, where the application is done before the emergence of the unwanted vegetation, and where the soil mobilizer is applied with an application rate 0.5 to 50 kg/ha, more preferably 2 to 40 kg/ha, and in particular with 5 to 20 kg/ha.

In another form the method may comprise the application of the water-insoluble herbicide (e.g. pendimethalin) and the soil mobilizer, where B is phenyl-C₁-C₄-alkyl (e.g. Ph-CH(CH₃)—), AO is ethyleneoxy or a mixture of ethyleneoxy group and propyleneoxy, A is a sulfate or phosphate, n is from 2 to 3, and m is from 3 to 50, and where the soil mobilizer is applied with an application rate 0.5 to 50 kg/ha, more preferably 2 to 40 kg/ha, and in particular with 5 to 20 kg/ha.

In another form the method may comprise the application of the water-insoluble herbicide (e.g. pendimethalin) and the soil mobilizer, where B is phenyl-C₁-C₄-alkyl (e.g. Ph-CH(CH₃)—), AO is ethyleneoxy or a mixture of ethyleneoxy group and propyleneoxy, A is a sulfate or phosphate, n is from 2 to 3, and m is from 3 to 50, where the application is done before the emergence of the unwanted vegetation, and where the soil mobilizer is applied with an application rate 0.5 to 50 kg/ha, more preferably 2 to 40 kg/ha, and in particular with 5 to 20 kg/ha.

In another form the method may comprise the application of the water-insoluble herbicide (e.g. pendimethalin) and the soil mobilizer, where B is phenyl-C₁-C₄-alkyl (e.g. Ph-CH(CH3)—), AO is ethyleneoxy, A is a sulfate or phosphate, n is from 2 to 3, and m is from 7 to 30, and where the soil mobilizer is applied with an application rate 0.5 to 50 kg/ha, more preferably 2 to 40 kg/ha, and in particular with 5 to 20 kg/ha.

In another form the method may comprise the application of the water-insoluble herbicide (e.g. pendimethalin) and the soil mobilizer, where B is phenyl-C₁-C₄-alkyl (e.g. Ph-CH(CH3)-), AO is ethyleneoxy, A is a sulfate or phosphate, n is from 2 to 3, and m is from 7 to 30, where the application is done before the emergence of the unwanted vegetation, and where the soil mobilizer is applied with an application rate 0.5 to 50 kg/ha, more preferably 2 to 40 kg/ha, and in particular with 5 to 20 kg/ha.

In one form the composition may comprise a water-insoluble herbicide (e.g. pendimethalin) and a soil mobilizer, where the weight ratio of the herbicide to the soil mobilizer is from 1:1 to 1:20, and where the soil mobilizer is of the formula I, where B is aryl-C₁-C₈-alkyl (e.g. phenyl-C₁-C₄-alkyl), AO is a C₂-C₃ alkyleneoxy group, A is a sulfate or phosphate group, n is from 2 to 3, and m is from 3 to 50.

In another form the composition is an aqueous composition and may comprise a water-insoluble herbicide (e.g. pendimethalin) and a soil mobilizer, where the weight ratio of the herbicide to the soil mobilizer is from 1:2 to 1:20, and where the soil mobilizer is of the formula I, where B is aryl-C₁-C₈-alkyl (e.g. phenyl-C₁-C₄-alkyl), AO is a C₂-C₃ alkyleneoxy group, A is a sulfate or phosphate group, n is from 2 to 3, and m is from 3 to 50.

In another form the composition is an aqueous composition and may comprise a water-insoluble herbicide (e.g. pendimethalin) and a soil mobilizer, where the weight ratio of the herbicide to the soil mobilizer is from 1:3 to 1:15, and where the soil mobilizer is of the formula I, where B is aryl-C₁-C₈-alkyl (e.g. phenyl-C₁-C₄-alkyl), AO is a C₂-C₃ alkyleneoxy group, A is a sulfate or phosphate group, n is from 2 to 3, and m is from 3 to 50.

In another form the composition is an aqueous composition and may comprise a water-insoluble herbicide (e.g. pendimethalin) and a soil mobilizer, where the weight ratio of the herbicide to the soil mobilizer is from 1:2 to 1:20, and where the soil mobilizer is of the formula I, where B is phenyl-C₁-C₄-alkyl (e.g. Ph-CH(CH3)-), AO is ethyleneoxy or a mixture of ethyleneoxy group and propyleneoxy, A is a sulfate or phosphate, n is from 2 to 3, and m is from 3 to 50.

In another form the composition is an aqueous composition and may comprise a water-insoluble herbicide (e.g. pendimethalin) and a soil mobilizer, where the weight ratio of the herbicide to the soil mobilizer is from 1:3 to 1:20, and where the soil mobilizer is of the formula I, where B is Ph-CH(CH3)-, AO is ethyleneoxy or a mixture of ethyleneoxy group and propyleneoxy, A is a sulfate or phosphate, n is from 2 to 3, and m is from 3 to 50.

In another form the composition is an aqueous composition and may comprise a water-insoluble herbicide (e.g. pendimethalin) and a soil mobilizer, where the weight ratio of the herbicide to the soil mobilizer is from 1:2 to 1:20, and where the soil mobilizer is of the formula I, where B is phenyl-C₁-C₄-alkyl (e.g. Ph-CH(CH3)-), AO is ethyleneoxy, A is a sulfate or phosphate, n is 3, and m is from 7 to 30.

In another form the composition is an aqueous composition and may comprise a water-insoluble herbicide (e.g. pendimethalin) and a soil mobilizer, where the weight ratio of the herbicide to the soil mobilizer is from 1:3 to 1:20, and where the soil mobilizer is of the formula I, where B is phenyl-C₁-C₄-alkyl (e.g. Ph-CH(CH3)-), AO is ethyleneoxy, A is a sulfate or phosphate, n is 3, and m is from 7 to 30.

The invention further relates to a use of the soil mobilizer of the formula I for enhancement of the herbicidal activity of a herbicide applied to soil. Typically, the herbicidal activity of the herbicide is enhanced compared to the herbicidal activity when applied without the soil mobilizer.

The following examples shall further illustrate the present invention.

### EXAMPLES

Soil Mobilizer A: Soprophor® FLK from Solvay (liquid, 20 wt % polyoxyethylene tristyrylphenol phosphate, Potassium Salt, 20 wt % of ethoxylated tristyrylphenol, 50-60 wt % propylene glycol, 1-5% water).
Soil Mobilizer B: Soprophor® 4D384 from Solvay (viscous liquid to paste, poly(oxy-1,2-ethanediyl), .alpha.-sulfo-.omega.-[tris(1-phenylethyl)phenoxy-, ammonium salt).

### Example 1

### Seed Depth Testmethod

Typically, the deeper the seeds of unwanted vegetation are in the soil the more difficult it is to control them with a water-insoluble herbicide. This greenhouse test was used to evaluate the herbicidal activity depending on seed depth of unwanted vegetation.

Pots were seeded with seed of slender foxtail grass (Alopecurus agrestis L.) at different seed depths of 0.1 cm, 1 cm and 3 cm. The soil was average loamy sand, pH 6.5, 4.6% humus content, particle size distribution: 71.5% sand 0.063-2.000 mm, 17.1% silt 0.002-0.063 mm, 11.4% clay <0.002mm.

An aqueous spray mixture of the herbicide and optionally a soil mobilizer were sprayed at an application volume of 200 liter/ha to the soil.

Ten and 20 days after this herbicidal treatment the percentage plant damage compared to the untreated control (“% PDCU”) were recorded, where 0% means no damage and 100% means that the plants were dead. All data points below represent the average of two pots.

### Example 2

The test method according to Example 1 was followed. An aqueous spray mixture (“Spray A”) was prepared by diluting with water
a) an aqueous suspension concentrate of containing 400 g/l pendimethalin and 125 g/l Soil Mobilizer A (“Pendi-SC”); and
b) Soil Mobilizer B (100% active content).

A comparative spray mixture (“Comparative Spray A”) was prepared by diluting only Pendi-SC with water, without the addition of Soil Mobilizer B. In the Comparative Spray A the weight ratio of the herbicide to the soil mobilizer of the formula I was 1:0.07.

The application rates were 1.2 kg/ha pendimethalin, 0.08 kg/ha Soil Mobilizer A, and in case of Spray A additionally 5 or 10 kg/ha Soil Mobilizer B.

The % PDCU was determined and the results are summarized in Table 1 (10 Days after treatment) and Table 2 (20 Days after treatment).

TABLE 1

| | | Comparative | | |
|---|---|---|---|---|
| Seed depth | | Spray A | Spray A (5 kg/ha) | Spray A (10 kg/ha) |
| 0.1 | cm | 92.5 | 96.5 | 95 |
| 1 | cm | 70 | 90 | 95 |
| 3 | cm | 65 | 75 | 85 |

TABLE 2

| | | Comparative | | |
|---|---|---|---|---|
| Seed depth | | Spray A | Spray A (5 kg/ha) | Spray A (10 kg/ha) |
| 0.1 | cm | 92.5 | 96.5 | 92.5 |
| 1 | cm | 77.5 | 85 | 95 |
| 3 | cm | 70 | 75 | 85 |

### Example 3

This example was made as in Example 2, but the application volume was reduced from 200 l/ha to 100 l/ha.

The application rates were 1.2 kg/ha pendimethalin, 0.15 kg/ha Soil Mobilizer A, and in case of Spray A additionally 10 kg/ha Soil Mobilizer B.

The % PDCU was determined and the results are summarized in Table 3 (10 Days after treatment) and Table 4 (20 Days after treatment).

TABLE 3

| | | |
|---|---|---|
| Seed depth | Comparative Spray A | Spray A |

| | | | |
|---|---|---|---|
| 0.1 | cm | 85 | 90 |
| 1 | cm | 73 | 90 |
| 3 | cm | 70 | 88 |

TABLE 4

| | | |
|---|---|---|
| Seed depth | Comparative Spray A | Spray A |

| | | | |
|---|---|---|---|
| 0.1 | cm | 75 | 93 |
| 1 | cm | 65 | 90 |
| 3 | cm | 65 | 88 |

### Example 4

This example was made as in Example 2, but the application volume was reduced from 200 l/ha to 50 l/ha.

The application rates were 1.2 kg/ha pendimethalin, 0.15 kg/ha Soil Mobilizer A, and in case of Spray A 10 kg/ha Soil Mobilizer B.

The % PDCU was determined and the results are summarized in Table 5 (10 Days after treatment) and Table 6 (20 Days after treatment).

TABLE 5

| | | |
|---|---|---|
| Seed depth | Comparative Spray A | Spray A |

| | | | |
|---|---|---|---|
| 0.1 | cm | 80 | 90 |
| 1 | cm | 78 | 88 |
| 3 | cm | 80 | 88 |

TABLE 6

| | | |
|---|---|---|
| Seed depth | Comparative Spray A | Spray A |

| | | | |
|---|---|---|---|
| 0.1 | cm | 73 | 93 |
| 1 | cm | 73 | 88 |
| 3 | cm | 83 | 85 |

### Example 5

The test method according to Example 1 was followed. An aqueous spray mixture (“Spray B”) was prepared by diluting with water
a) an aqueous suspension concentrate of containing 500 g/l trifludimoxazin (“Triflu-SC”); and
b) Soil Mobilizer B (100% active content).

A comparative spray mixture (“Comparative Spray B”) was prepared by diluting only Triflu-SC with water, without the addition of Soil Mobilizer B. Triflu-SC was free of a soil mobilizer of the formula I.

The application rates were 13 or 18 g/ha trifludimoxazin and in case of Spray B 10 kg/ha Soil Mobilizer B.

The % PDCU was determined and the results for 13 g/ha herbicide are summarized in Table 7 (10 Days after treatment) and Table 8 (20 Days after treatment); and for 18 g/ha herbicide are summarized in Table 9 (10 Days after treatment) and Table 10 (20 Days after treatment

TABLE 7

| | | |
|---|---|---|
| Seed depth | Comparative Spray B | Spray B |

| | | | |
|---|---|---|---|
| 0.1 | cm | 73 | 80 |
| 1 | cm | 65 | 75 |
| 3 | cm | 73 | 88 |

TABLE 8

| | | |
|---|---|---|
| Seed depth | Comparative Spray B | Spray B |

| | | | |
|---|---|---|---|
| 0.1 | cm | 78 | 90 |
| 1 | cm | 68 | 80 |
| 3 | cm | 80 | 95 |

TABLE 9

| | | |
|---|---|---|
| Seed depth | Comparative Spray B | Spray B |

| | | | |
|---|---|---|---|
| 0.1 | cm | 78 | 75 |
| 1 | cm | 85 | 88 |
| 3 | cm | 80 | 93 |

TABLE 10

| | | |
|---|---|---|
| Seed depth | Comparative Spray B | Spray B |

| | | | |
|---|---|---|---|
| 0.1 | cm | 75 | 85 |
| 1 | cm | 97 | 99 |
| 3 | cm | 88 | 98 |

1. A method for controlling unwanted vegetation comprising the application of a water-insoluble herbicide and a soil mobilizer to a soil, where the weight ratio of the herbicide to the soil mobilizer is from 1:0.8 to 1:50, and where the soil mobilizer is of the formula I 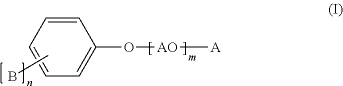
where
B is alkyl, aryl or arylalkyl,
AO is C₂-C₆ alkyleneoxy,
A is a sulfate or phosphate group,
n is from 1 to 3, and
m is from 1 to 100.

2. The method according to claim 1 where the soil mobilizer is applied with an application rate 0.5 to 50 kg/ha.

3. The method according to claim 1 where the weight ratio of the herbicide to the soil mobilizer is from 1:1 to 1:20.

4. The method according to claim 1 where AO is ethyleneoxy or a mixture of ethyleneoxy and propyleneoxy.

5. The method according to claim 1 where m is from 5 to 50.

6. The method according to claim 1 where the herbicide has a solubility in water of up to 10 g/l at 20° C. at pH 7.

7. The method according to claim 1 where the application is done before the emergence of the unwanted vegetation.

8. The method according to claim 1 where B is aryl or arylalkyl.

9. The method according to claim 1 where n is from 2 to 3.

10. The method according to claim 1 where B is aryl-C₁-C₈-alkyl
AO is a C₂-C₃ alkyleneoxy,
A is a sulfate or phosphate group,
n is from 2 to 3, and
m is from 3 to 50.

11. A composition comprising a water-insoluble herbicide and a soil mobilizer, where the weight ratio of the herbicide to the soil mobilizer is from 1:0.8 to 1:50, and where the soil mobilizer is of the formula I as defined in claim 1.

12. The composition according to claim 11 where the weight ratio of the herbicide to the soil mobilizer is from 1:1 to 1:20.

13. The composition according to claim 11 where the herbicide has a solubility in water of up to 10 g/l at 20° C. at pH 7.

14. The composition according to claim 11 which is an aqueous composition comprising at least 50 wt % water.

15. The composition according to claim 11 where the herbicide is suspended in particulate form or in microencapsulated form.

16. The composition according to claim 11 where the herbicide comprises pendimethalin.

17. A method for enhancement of the herbicidal activity of a herbicide applied to soil, the method comprising the use of the soil mobilizer of the formula I as defined in claim 1.

18. The method according to claim 2 where the soil mobilizer is applied with an application rate 2 to 40 kg/ha.

19. The method according to claim 3 where the weight ratio of the herbicide to the soil mobilizer is from 1:2 to 1:10.

20. The method according to claim 10 where B is aryl-C₁-C₄-alkyl.
